(19) United States
(12) Patent Application Publication
(10) Pub. No.: US 2002/0116203 A1
(43) Pub. Date: Aug. 22, 2002

(54) System and method for managing job resumes

(76) Inventors: Darrel D. Cherry, Meridian, ID (US); Garth F. Schmeling, Boise, ID (US); Daniel J. Dyer, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/789,338

(22) Filed: Feb. 20, 2001

(51) Int. Cl. G06F 17/60

(52) U.S. Cl. 705/1

(57) ABSTRACT

The present invention provides an improved system and method for managing job resumes using one or more computers with at least one agent adapted to process a job requisition and a resume entry. The present invention includes a job requisition agent for receiving one or more job requisitions with predefined search criteria, and to create a job requisition record including the predefined search criteria for each of the job requisitions. There is also a master criteria list that includes all the predefined search criteria from all the job requisition records. A resume processing agent is further included, and it is for receiving a resume entry and create a resume record including any matched search criteria from the master criteria list for each of the resume entries. Lastly, there is a job matching agent for matching any of the resume record(s) to each job requisition record according to the predefined search criteria of the job requisition record and the matched search criteria of the resume record.

The present invention generally relates to an improved system and method for managing job resumes. More specifically, it relates to an improved system and method for managing job resumes using at least one server having at least one agent adapted to process a job requisition and a resume entry over a network.

Most conventional resume management systems generally require the use of considerable human intervention, which is inefficient, costly and time consuming. For example, in order for a resume to be routed to the right manager, somebody must review the resume and determine who should be the proper recipient of a particular resume. However, this process may require several days from the receipt of the resume to the time the manager receives the resume.

One prior art method attempted to reduce human intervention by providing a paperless resume management system. In this method, a person first scanned the resume into a scanner connected to a server, and the server then routed the scanned resume file to a designated client computer. The user of that client computer reviewed the resume and determined whether to send the resume file to the proper person(s) via the network. As a result, the resume was routed electrically through the network, creating a paperless office.

The problem with this prior method was that the routing of the resume required human intervention and judgment. Furthermore, this prior method provided a paperless office that was limited to a scanner connected to a network, and did not provide for other methods of receiving a resume, such as one that was already in digital form. In addition, the managers could not predefine any job criteria or communication preferences, which contributed to the overall inefficiency of the system.

The present invention is directed to an improved system and method for managing job resumes. The system and method provides an integrated computer-implemented resume management system that minimizes human intervention, increases efficiency and accuracy, and thereby reduces operating costs. In addition, the present invention permits the managers to customize and tailor their job requisitions and avoid unnecessary review of unqualified candidates. A wide range of communication media are available for candidates to submit their resumes, including the Internet.

More particularly, the system and method are adapted to utilize one or more computers having at least one agent adapted to process a job requisition and a resume entry. The present invention can be implemented in a wide spectrum of options. For example, it is contemplated that the present invention can be implemented on a large scale network, such as the Internet, or a stand-alone personal computer without network service. However, the preferred system would be implemented over a large scale network, such as the Internet, for more flexibility and compatibility. In addition, with the Internet, the resumes can be automatically routed to the managers by the computer without additional human intervention.

The present invention provides an improved system and method for managing job resumes using one or more computers with at least a job requisition agent adapted to process a job requisition and a resume entry. As used herein, an agent is a computer or a software module loaded on a computer or other processing means, depending upon the particular implementation that is employed. The job requisition agent is for receiving a job requisition, and using predefined search criteria, create a job requisition record for each of the job requisitions. A master criteria list is created that includes all the predefined search criteria from all the job requisition records. A resume processing agent is preferably further included for receiving a resume entry and create a resume record including any matched search criteria from the master criteria list for each of the resume entries. Lastly, there preferably is a job matching agent for matching any of the resume record(s) to each job requisition record according to the predefined search criteria of the job requisition record and the matched search criteria of the resume record.

The present invention further provides a method that includes the steps of receiving one or more job requisition records with predefined search criteria, maintaining a master criteria list of all the predefined search criteria from all the job requisition record(s), receiving one or more resume records with matched search criteria from the master criteria list, and matching any of the resume record(s) to each job requisition record according to the predefined search criteria of the job requisition record and the match search criteria of the resume record.

### DESCRIPTION OF THE DRAWINGS

FIG. 1 is an exemplary schematic diagram of a network system in which the present invention can be implemented;

FIG. 2 is a flow chart illustrating the preferred overall general scheme of the present invention;

FIG. 3 is a flow chart illustrating the preferred functionality of the resume processing agent shown in FIG. 2;

FIG. 4 is a flow chart illustrating the preferred functionality of the manager information agent shown in FIG. 2;

FIG. 5 is a flow chart illustrating the preferred functionality of the job requisition agent shown in FIG. 2;

FIG. 6 is a flow chart illustrating the preferred functionality of the job matching agent shown in FIG. 2;

FIG. 7 is a flow chart illustrating the preferred functionality of the storage manager agent shown in FIG. 2;

FIG. 8 is a flow chart illustrating the preferred functionality of the notification agent shown in FIG. 2; and,

FIG. 9 is a flow chart illustrating the preferred functionality of the publishing agent shown in FIG. 2.

### DETAILED DESCRIPTION

Broadly stated, the present invention is directed to an improved system and method for managing job resumes. The system and method provides an integrated computer-implemented resume management system that automatically and efficiently manages job resumes with minimal human intervention. As a result, the human resource administration is more efficient and accurate, with concomitantly reduced operating costs. The present invention enables managers to customize and tailor job requisitions to screen and cull out unqualified resumes. Also, by taking advantage of the flexibility and availability of the Internet, the present invention enables candidates to submit their resumes online in a number of ways.

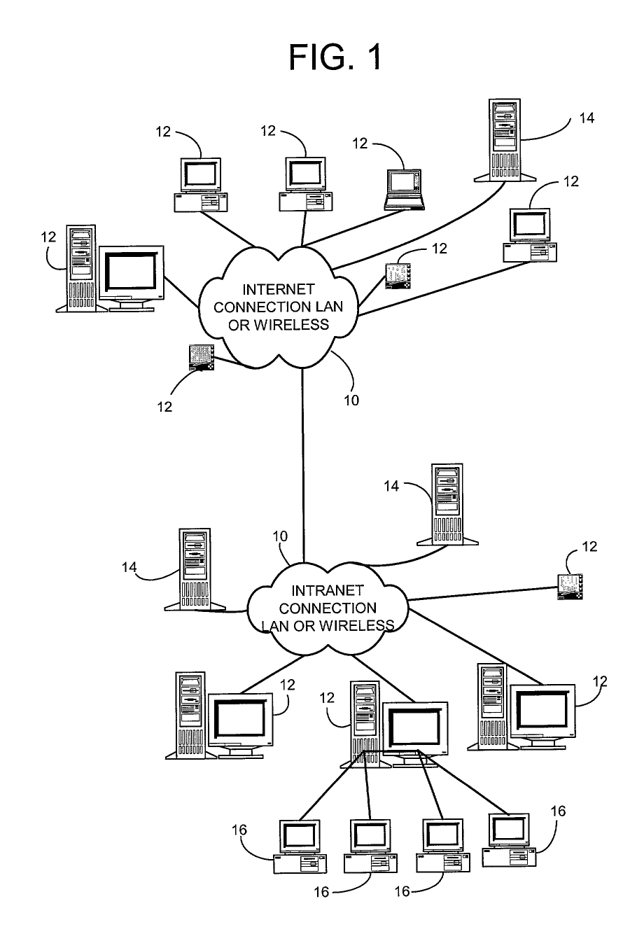

Turning now to the drawings and particularly FIG. 1, the system in which the present invention can be implemented as part of a preferred wide area network is indicated generally at 10. A plurality of client computers (“clients”) 12 are connected to a plurality of network servers (“servers”) 14 via the network 10. As an example, the clients 12 can be network servers, which in turn are connected to workstations 16 within an intranet. However, the client 12 can also be a hand-held personal digital assistant. The present invention can be implemented using a variety of connections as well, such as the Internet or wireless communication system. The connection functions primarily to allow the server and the client to communicate and transfer data, preferably but not necessarily using real time communication. For better readability, “a” client machine or resume record, as an example, will be sometimes referred to. However, it should be understood that the use of “a” also refers to “one or more”.

The Internet is the preferable network connection 10 because it provides a very flexible and universal way of communicating. However, the present invention can be implemented practically in any number of ways, ranging from a large scale network to a standalone personal computer, that may also change with evolving technology. To further the complexity of the various network types that may be available, issues of bandwidth, reliability and security of the network are important considerations. As a result, an explanation of the current preferred embodiment of the network topology is given as an example and other networks and connections are contemplated and within the scope of the present invention.

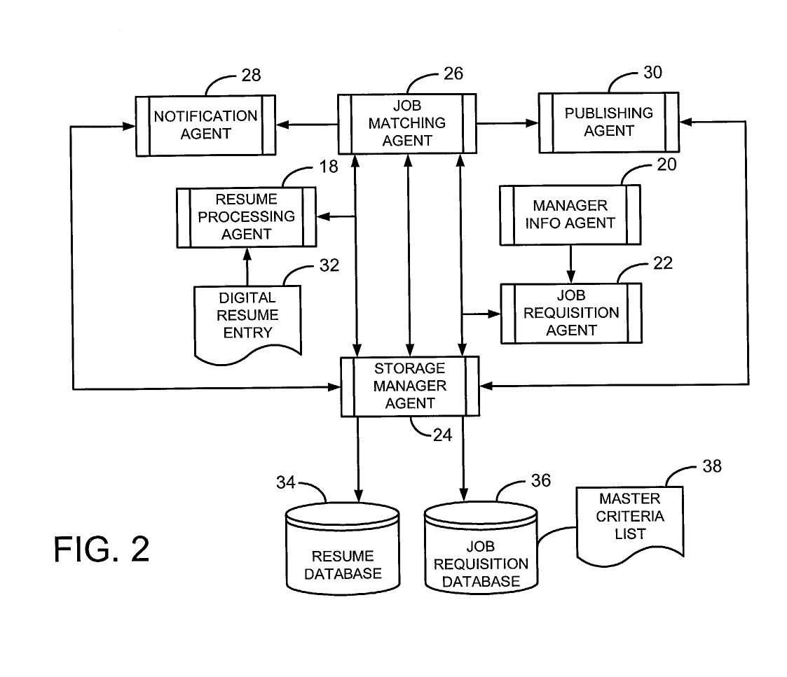

A flow chart of the preferred overall general scheme of the present invention is shown in FIG. 2 for an overview of a system with agents that generally interact with each other. There are seven agents shown, specifically a resume processing agent 18, a manager information agent 20, a job requisition agent 22, a storage manager agent 24, a job matching agent 26, a notification agent 28, and a publishing agent 30. The resume processing agent 18 is set up to receive a digital resume entry 32, and the manager information agent 20 and the job requisition agent 22 are used by a manager to create job requisitions. Each of these agents will be discussed in greater detail in the following figures.

In addition, the storage manager agent 24 is a management system for a resume database 34 and a job requisition database 36. As the name indicates, the resume database 34 stores the resumes submitted by candidates, and the job requisition database 36 stores the job requisitions submitted by managers. Each job requisition includes predefined search criteria, which are stored in a master criteria list 38 that includes all the predefined search criteria from all the job requisitions in the system. Although there are a total of seven agents and two databases shown, any number of agents and databases can also be implemented. In fact, other types of agents can also be used depending upon the implementation needed for a particular human resource administration. It is important to note that the present invention contemplates customization and alteration in order to meet the demand of different professions and administration structures, and these other implementations are within the scope of the present invention.

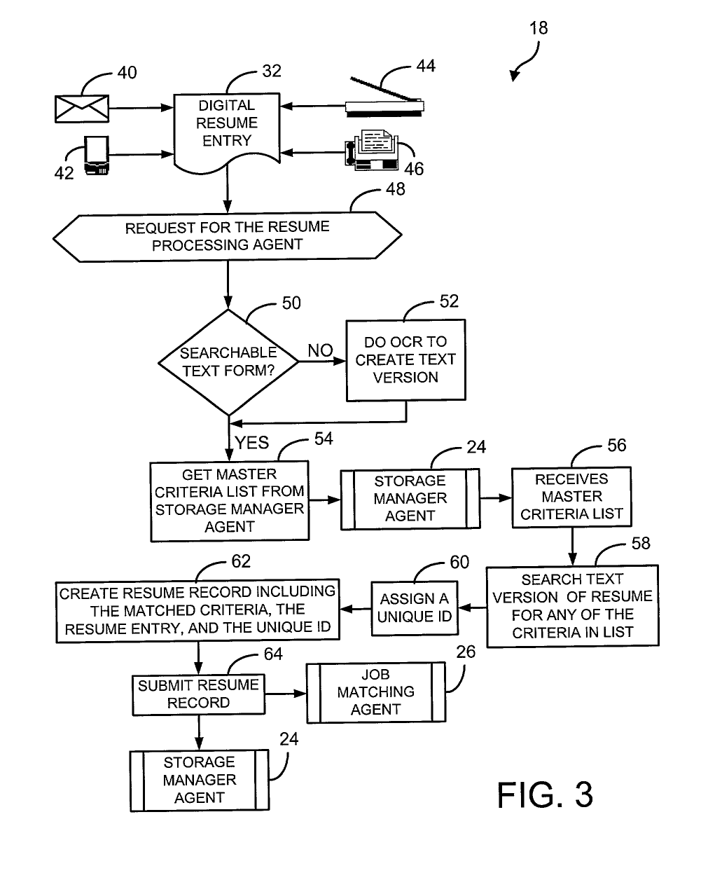

The flow chart of FIG. 3 illustrates the preferred functionality of the resume processing agent 18, which is triggered by a user submitting a digital resume entry 32 through a client 12 using, for example, email 40, personal digital assistants 42, scanning devices 44, or fax machines 46. Once the resume processing agent 18 is triggered (block 48), the resume processing agent 18 next determines whether the resume entry is in searchable text form (block 50). If necessary, the resume entry is converted into a searchable text form using preferably optical character recognition technology (block 52).

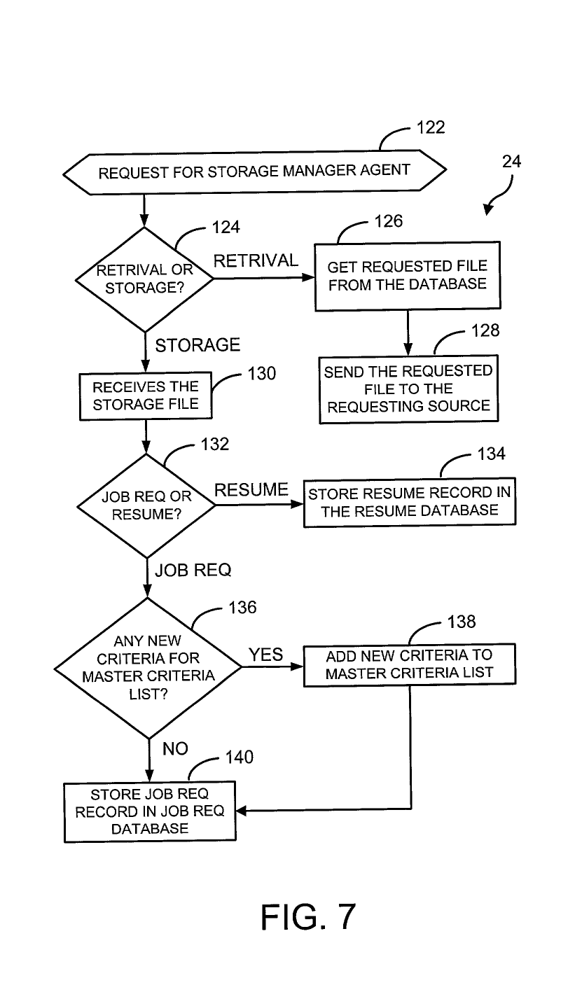

Once the resume entry is in searchable text form (block 50), the resume processing agent retrieves the master criteria list from the storage manager agent 24 (block 54). The storage manager agent 24 responds by sending the master criteria list to the resume processing agent (shown in FIG. 7). After the master criteria list (block 58) is received, the resume entry is searched for any matched search criteria from the master criteria list. Put another way, the resume entry is searched to see if there is anything in the resume entry that satisfies any search criteria listed in the master criteria list. The preferred search criteria is based on keywords. However, the present invention contemplates more complex implementations, such as variables and Boolean operations, and these and other implementations of search criteria are within the scope of the present invention.

Once the matched search criteria are located for the resume entry (block 58), a unique identification will be assigned (block 60). And a resume record, which includes the resume entry, all the matched search criteria, and the unique identification, is created by the resume processing agent 18 (block 62). The resume record is submitted (block 64) to the storage manager agent 24 and the job matching agent 26.

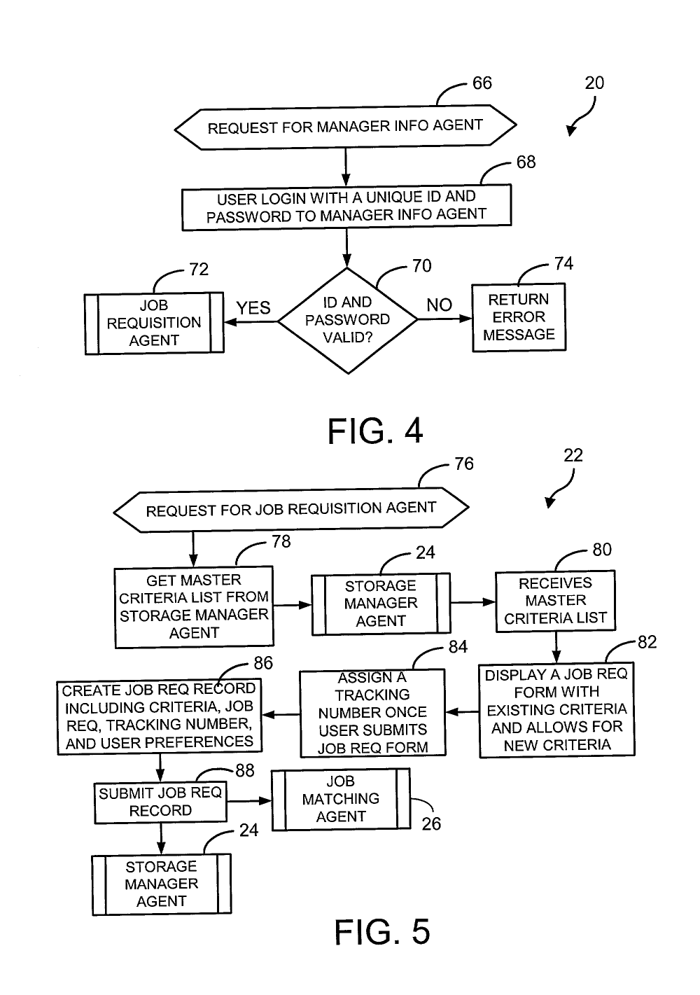

A flow chart of the preferred functionality of the manager information agent 20 is shown in FIG. 4. The manager information agent 20 is triggered by a request (block 66), generally from a manager user logging on. In the preferred embodiment, the manager user preferably logs in with a unique identification and password (block 68) through the Internet. The manager information agent 20 then determines whether the identification and password are valid (block 70) If so, a request is sent to the job requisition agent 22 (block 72), otherwise an error message is sent back to the manager user (block 74). Although a method for the manager user to login is shown, the manager user does not necessarily have to login at all. For example, if the present invention is implemented on an intranet that does not require a security check to access the job requisition agent 22, the manager information agent 20 will not be used at all. But the manager information agent 20 is preferably implemented for an Internet connection.

A flow chart of the preferred functionality of the job requisition agent 22 is shown in FIG. 5. The job requisition agent 22 is triggered by a request (block 76), which was indicated previously in FIG. 4. Once triggered, the job requisition agent requests the master criteria list from the storage manager agent (block 78), which the storage manager agent sends. Once the job requisition agent receives the master criteria list (block 80), it preferably displays a job requisition form with all the search criteria that are available from the master criteria list (block 82). The job requisition form also allows the manager user to enter and add new criteria, if desired (block 82). The manager user then fills out the job requisition form and submits it when finished.

After the manager user submits the job requisition form, the job requisition agent 22 assigns a tracking number to the job requisition form (block 84), and creates a job requisition record that includes the job requisition, the predefined search criteria, the tracking number and user preferences (block 86). The job requisition record is then submitted (block 88) to the storage manager agent 24 and the job matching agent 26.

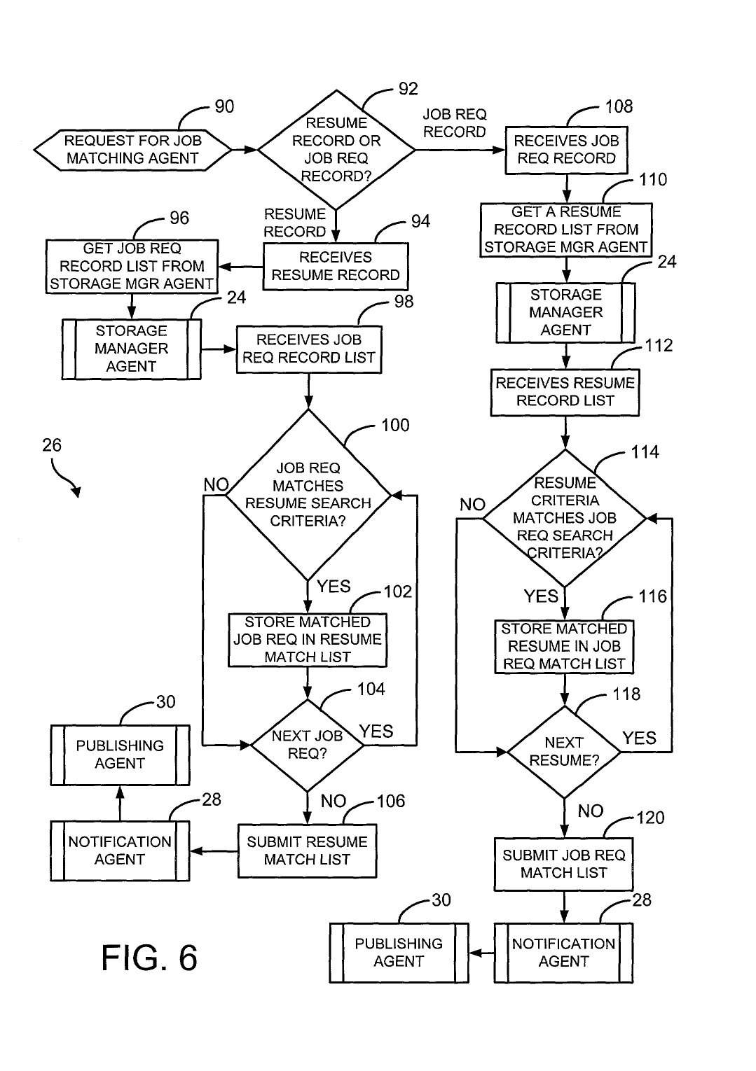

A flow chart illustrating the preferred functionality of the job matching agent 26 is shown in FIG. 6. As the previous figures have shown, the job matching agent 26 is triggered by a request by the other agents (block 90). When a request comes in, the job matching agent must first determine whether the request is for a resume record or a job requisition record (block 92). When the request is for a resume record, the job matching agent 26 receives a resume record (block 94). The job matching agent 26 then retrieves a job requisition record list that includes all the job requisition records available in the system from the storage manager agent (block 96), which it accordingly receives from the storage manager agent (block 98). It is next determined whether the predefined search criteria of a job requisition from the job requisition record list matches the matched search criteria of the resume record (block 100).

The job requisition record is stored in a resume match list (block 102) only when the job requisition matches the resume record (block 100). The job matching agent next determines whether there is a next job requisition record in the job requisition record list (block 104). If there is another job requisition available (Block 104), the process repeats for the next job requisition. More particularly, the process is looped back to the step of determining whether the predefined search criteria of this next job requisition matches the matched search criteria of the resume record (block 100). However, when there are no more job requisition records in the job requisition record list (block 104), the job matching agent submits the resume match list (block 106), which now should have a plurality of matched job requisition records, to the notification agent 28 and the publishing agent 30.

When the request is for a job requisition record (block 92), the job matching agent 26 receives a job requisition record (block 108). In that event, the matching agent 26 retrieves a resume record list that includes all the resume records from the storage manager agent 24 (block 110). The storage manager agent 24 accordingly responds to the request, and the job matching agent 26 receives the requested resume record list from the storage manager agent (block 112). Similarly, it is determined whether the matched search criteria of a resume record from the resume record list matches the predefined search criteria of the job requisition (block 114). If such a match exists (block 114), the resume record is stored in a job requisition match list (block 116). The job matching agent next determines whether there is a next resume in the resume record list (block 118), if so, it loops back and repeat the step of determining whether the next resume record matches the job requisition record (block 114). Once there are no other resume records in the resume record list (block 118), the job requisition match list is submitted (block 120) to the notification agent 28 and the publishing agent 30.

A flow chart of the preferred functionality of the storage manager agent is shown in FIG. 7. Similar to the other agents, the storage manager agent is triggered by a request from other agents (block 122). When the storage manager agent receives a request, it determines whether the request is for retrieval or storage (block 124). If it is a retrieval request (block 124), it retrieves the requested record from the database (block 126) and sends it to the requesting source (block 128). If, however, the request is for storage (block 124), it receives the storage record from the requesting source (block 130). Next, it determines whether the storage record is a resume record or job requisition record (block 132), and simply stores the storage record in the database (block 134) if it is a resume record. On the other hand, if it is a job requisition record (block 132), it searches the job requisition record to determine if there are any new search criteria that must be added to the master criteria list (block 136). Any new search criteria found by the storage manager agent are added to the master criteria list (block 138), at which time, the job requisition record is added to the job requisition database.

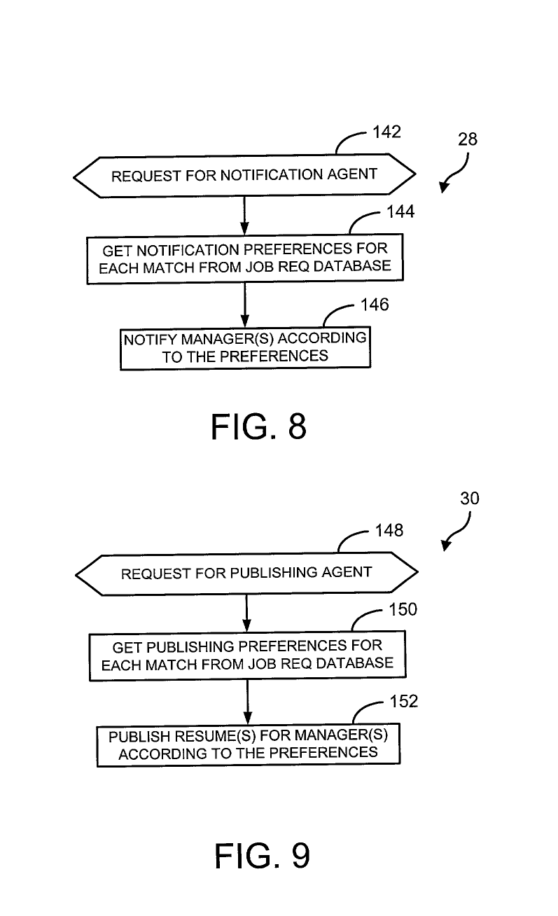

Now turning to FIGS. 8 and 9, a flow chart of the preferred functionality for the notification agent and the publishing agent are respectively shown. The notification agent is triggered again by a request from other agents in the system (block 142). For each match list, which can be either the resume match list or the job requisition match list (shown in FIG. 6), the notification agent obtains the preferences of each job requisition (block 144) and notifies the manager according to these preferences (block 146). Since there may be a plurality of job requisition records in the resume match list, the notification agent looks up the preferences of each job requisition record and notifies the manager user according to each of the preferences of the job requisition. On the other hand, since the job requisition match list contains only resume records, the notification agent only has to look up the preferences of the job requisition that initiated the process.

Similarly, the publishing agent functionality is triggered by a request (block 148), resulting in the preferences of the job requisition record(s) to be obtained. And the resume record(s) are published according to the preferences of each job requisition record. Again, with the resume record match list, the resume is published for each job requisition in the list, which may result in a single resume being published at several locations. On the other hand, if the job requisition match list includes multiple resumes, the resumes are only published at one location according to the preference of the job requisition that initiated the process.

From the foregoing description, it should be understood that an improved system and method for managing job resumes has been shown and described, which has many desirable attributes and advantages. The system and method can automatically and efficiently manage multiple job resumes with minimal human intervention while at the same time allowing more customization of job requisitions by the managers. The resumes are automatically searched and routed to the proper manager without the need of a human operator. Consequently, the present invention is more efficient and accurate than the prior systems. In addition, it provides greater flexibility, since it can be implemented over the Internet to provide a variety of ways for users to submit their resume.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A system for managing job resumes using at least one computer having at least one agent adapted to process a job requisition and a resume entry, comprising:
a job requisition agent for receiving a job requisition having predefined search criteria, and to create a job requisition record including said predefined search criteria for each job requisition;
a master criteria list of all said predefined search criteria from said job requisition records;
a resume processing agent for receiving a resume entry, and for creating a resume record including any matched search criteria from said master criteria list for said resume entry; and,
a job matching agent for matching any said resume record to each said job requisition record according to said predefined search criteria of said job requisition record and said match search criteria of said resume record.

2. The system as defined in claim 1 wherein said job requisition record further includes said job requisition, unique tracking number and user preferences.

3. The system as defined in claim 1 wherein said resume record further includes said resume entry and a unique identification.

4. The system as defined in claim 1 further comprising:
a database for storing said master criteria list, said resume records and said job requisition record; and,
a storage manager agent for responding to a retrieval request or a storage request for said database.

5. The system as defined in claim 4 wherein said storage manager agent:
retrieves a requested record from said database and forwards said requested record to a requesting source when responding to a retrieval request;
receives a storage record from a requesting source, and determining whether said storage record is a resume record or job requisition record;
stores said storage record in said database when said storage record is a resume record; and,
determines whether there is a new search criteria in said storage record when said storage record is a job requisition record.

6. The system as defined in claim 5 wherein said storage manager:
stores all said new search criteria in said master criteria list when there is a new search criteria in said job requisition record; and,
stores said job requisition record in said database.

7. The system as defined in claim 1 further comprising a manager information agent for validating user access to said job requisition agent.

8. The system as defined in claim 7 wherein said manager information agent:
determines whether the user entered a valid identification and password;
sends an error message when the user enters an invalid identification and password; and,
allows access to said job requisition agent when the user enters a valid identification and password.

9. The system as defined in claim 1 wherein said job requisition agent retrieves said master criteria list and display a job requisition form that includes all said search criteria from said master criteria list and allows for new criteria to be added.

10. The system as defined in claim 1 wherein said job requisition agent:
submits said job requisition record to said job matching agent, and,
stores said job requisition record to a database.

11. The system as defined in claim 3 wherein said resume processing agent assigns said unique identification.

12. The system as defined in claim 1 wherein said resume processing agent:
determines whether said resume entry is in searchable text form;
converts said resume entry into a searchable text form only when said resume entry is not in searchable text form; and,
searches said resume entry for any matched search criteria from said master criteria list.

13. The system as defined in claim 12 wherein said resume processing agent converts said resume entry using optical character recognition.

14. The system as defined in claim 1 wherein said resume processing agent:
submits said resume record to said job matching agent; and,
stores said resume record to a database.

15. The system as defined in claim 1 wherein said job matching agent:
receives a request from said resume processing agent or job requisition agent;
determines whether said request is for a resume record or a job requisition record;
receives a resume record when said request is for a resume record;
receives a job requisition record when said request is for a job requisition record;
retrieves a job requisition list having all said job requisition record(s) for said resume record; and,
retrieves a resume record list having all said resume record(s) for said job requisition record.

16. The system as defined in claim 15 wherein said job matching agent:
determines whether the matched search criteria of a resume record from said resume record list matches said predefined search criteria of said job requisition record;
determines whether the matched search criteria of a next resume record from said resume record list matches said predefined search criteria of said job requisition until all said resume records are processed; and,
stores any said resume record in a job requisition match list when said matched search criteria of said resume record matched said predefined criteria of said job requisition record; and,
submits said job requisition match list to an agent for processing.

17. The system as defined in claim 16 wherein said job matching agent submits said requisition match list to a notification agent and a publishing agent.

18. The system as defined in claim 15 wherein said job matching agent:
determines whether said predefined search criteria of a job requisition record from said job requisition list matches said matched search criteria of said resume record when a job requisition list is retrieved;
determines whether said predefined search criteria of a next job requisition record from said job requisition list matches said matched search criteria of said resume record until all said job requisition record(s) are processed;
stores any said job requisition record in a resume match list when said predefined search criteria of said job requisition record matches said matched search criteria of said resume record; and,
submits said resume match list to an agent for processing.

19. The system as defined in claim 18 wherein said job matching agent submits said requisition match list to a notification agent and a publishing agent.

20. The system as defined in claim 1 further comprising:
a notification agent for notifying users according to user preference defined in said job requisition record; and,
a publishing agent for publishing said matched resume record(s) according to user preference defined in said job requisition record, and said matched job acquisition record(s) according to user preference defined in said resume record.

21. A method for managing job resumes using at least one computer having at least one agent adapted to process a job requisition and a resume entry over a network, said method comprising the steps of:
receiving at least one job requisition record having predefined search criteria;
maintaining a master criteria list of all said predefined search criteria for all said at least one job requisition record;
receiving at least one resume record having matched search criteria from said master criteria list; and,
matching any said at least one resume record to each said job requisition record according to said predefined search criteria of said job requisition record and said match search criteria of said resume record.

22. The method according to claim 21 wherein said master criteria list, said at least one resume record, and said at least one job requisition record are stored in at least one database.

23. The method according to claim 22 further comprising the step of managing said database by said at least one agent.

24. The method according to claim 23 wherein said step of managing said database further comprising the steps:
determining whether said database is receiving a retrieval request or storage request;
retrieving said requested record if said database received a retrieval request; and,
receiving a storage record if said database received a storage request.

25. The method according to claim 24 wherein said step of retrieving said requested record further comprising the step of sending the requested record to the requesting source.

26. The method according to claim 24 wherein said step of receiving a storage record further comprising the steps of:
determining whether said storage record is a job requisition record or a resume record;
storing said storage record in said at least one database when said storage record is a resume record; and,
determine whether there is at least one new search criteria in said storage record when said storage record is a job requisition record.

27. The method according to claim 26 wherein said step of determining whether there is at least one new search criteria further comprising the steps of:
adding said at least one new search criteria to said master criteria list only when there is at least one new search criteria; and,
storing said job requisition record in said at least one database.

28. The method according to claim 21 wherein prior to said step of receiving at least one job requisition record further comprising the steps of:
determining whether a unique identification and password from a user is valid;
returning an error message if said unique identification and password is invalid; and,
displaying a job requisition form that includes all search criteria from said master criteria list and allows for new search criteria to be added if said unique identification and password is valid.

29. The method according to claim 28 wherein said step of displaying a job requisition form further comprising the steps of:
assigning a tracking identification for said job requisition once said job requisition is submitted by the user;
creating a job requisition record including predefined search criteria; and,
submitting said job requisition record to said at least one agent.

30. The method according to claim 21 wherein prior to said step of receiving at least one resume record further comprising the steps of:
receiving a resume entry from a user;
determining whether said resume entry is in searchable text form;
converting said resume entry into a searchable text form only when said resume entry is not in searchable text form;
searching said resume entry for any matched search criteria from said master criteria list;
assigning an unique identification for said resume entry;
creating a resume record including said resume entry, said matched criteria and said unique identification; and,
submitting said resume record to said at least one agent.

31. The method according to claim 21 wherein prior to said step of matching any said at least one resume record further comprising the steps of:
determining whether a request is for a resume record or a job requisition record;
receiving a job requisition record when said request is for a job requisition record; and,
receiving a resume record when said request is for a resume record.

32. The method according to claim 31 wherein said step of receiving a job requisition record further comprising the steps of:
retrieving a resume record list having all said at least one resume record;
determining whether said match search criteria of a resume record from said resume record list matches said predefined search criteria of said job requisition record;
storing said resume record in a job requisition match list only when said match search criteria of a resume record from said resume record list matches said predefined search criteria of said job requisition record; and,
determining whether there is a next resume record in said resume record list.

33. The method according to claim 32 wherein said step of determining whether there is a next resume record further comprising the step of submitting said job requisition match list when there is not a next resume record in said resume record list, otherwise repeat the process for said next resume record.

34. The method according to claim 33 wherein said step of submitting said job requisition match list further comprising the steps:
notifying at least one user according to preferences of said job requisition record; and,
publishing each resume record in said job requisition match list according to preferences of said job requisition record.

35. The method according to claim 31 wherein said step of receiving a resume record further comprising the steps of:
retrieving a job requisition record list having all said at least one job requisition record;
determining whether said predefined search criteria of a job requisition record from said job requisition record list matches said matched search criteria of said resume record;
storing said job requisition record in a resume match list only when said predefined search criteria of a job requisition record from said job requisition record list matches said matched search criteria of said resume record; and,
determining whether there is a next job requisition record in said job requisition record list.

36. The method according to claim 35 wherein said step of determining whether there is a next job requisition record further comprising the step of submitting said resume match list when there is not a next job requisition record in said job requisition record list, otherwise repeat the process for said next resume record.

37. The method according to claim 36 wherein said step of submitting said resume match list further comprising the steps of:
notifying at least one user according to preferences of each said job requisition record in said resume match list; and,
publishing said resume record according to preferences of each said job requisition record in said resume match list.

38. A computer program product comprising a computer usable medium having computer readable program code embodied thereon that when executed causes a computer to:
receive at least one job requisition record having predefined search criteria;
maintain a master criteria list of all said predefined search criteria for all said at least one job requisition record;
receive at least one resume record having matched search criteria from said master criteria list; and,
match any said at least one resume record to each said job requisition record according to said predefined search criteria of said job requisition record and said match search criteria of said resume record.
